(19) United States
(12) Patent Application Publication
(10) Pub. No.: US 2006/0179404 A1
(43) Pub. Date: Aug. 10, 2006

(54) Method for a browser auto form fill

(75) Inventors: Stephen Mark Yolleck, Sunnyvale, CA (US); Elizabeth I. Yang, Palo Alto, CA (US); David Anton Walters, Sunnyvale, CA (US); Dane A. Glasgow, Los Gatos, CA (US)

Correspondence Address: SHOOK, HARDY & BACON L.L.P.;(c/o MICROSOFT CORPORATION), 2555 GRAND BOULEVARD, KANSAS CITY, MO, 64108-2613, US

(73) Assignee: Microsoft Corporation

(21) Appl. No.: 11/053,217

(22) Filed: Feb. 8, 2005

(51) Int. Cl. G06F 17/00

(52) U.S. Cl. 715/507

(57) ABSTRACT

The present invention provides at least a method for automatically filling forms appearing on web pages. With respect to the present invention, a user populates personal information such as addresses, credit cards, and passwords in a tool to subsequently fill forms without re-typing the same. The user may input the personal information or retrieve it from another source. The tool gives the user flexibility in selecting the personal information to be populated in the form.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

This invention relates to the field of computer software using web browsers and toolbars.

### BACKGROUND OF THE INVENTION

Current form fill systems require a user to fill in a form, with assistance, field by field. Form fill solutions are limited to a very rigid structure or require that the user take a field by field edit approach to complete an online form. Today, if the user goes to a standard shipping form on a web page and fills the form, the user typically has one choice for a billing address and one choice for a shipping address in some form fill solutions. These may be presented as options based on previously entered user information. In many cases, such choices may not be satisfactory since the shipping address often changes. In some other form fill solutions, the user may have the ability to select multiple choices for addresses but the information cannot be readily changed with speed or minimum effort. A better user experience is needed that provides more flexibility.

In general, users desire to have more flexibility over their web browsing experience. One of the drawbacks of current web experiences involves encountering websites that repeatedly ask the users to enter the same information. Sometimes, the user may type information into a form on a web page only to find the typed data missing after refreshing the page or referring back to another page and then going forward to the current page again. A better experience is needed to alleviate these problems, or reduce them, by providing users with a method that allows users to automatically fill forms, and also enhance their experience by giving users more flexibility in the type of information that may be populated in the form.

### BRIEF SUMMARY OF THE INVENTION

The present invention identifies data clusters and fills appropriate fields with user information in a form as a unit. In addition, the present invention provides the user an interface to update selections made to the form. The user may initially populate user information through direct input to a computing device or by retrieving user information from another source. Subsequently, the user information is filled into forms encountered on a web page.

In a first aspect, a method for creating profiles for automatically filling web forms on a web page is provided. The method includes operating, at a computing device, a web browser and a form-fill tool located on a toolbar in communication with the web browser. Upon operation, a user populates, from a data source, data fields in the form-fill tool corresponding to one or more profiles. Subsequently, either a form-fill button associated with the form-fill tool on the toolbar is selected to automatically populate data fields in forms displayed in web pages with data pre-populated and stored in the form-fill tool, or data pre-populated in the form-fill tool is automatically populated into fields in a form without manual intervention. A password is required for data pre-populated in the form-fill tool associated with secure or private information. User-selectable categories corresponding to grouped profiles are displayed. The user-selectable categories contain a listing of profiles to allow the user to select a different profile to change information previously populated in the forms.

In a second aspect, a method for detecting data fields in a form displayed on a web page is provided. The method includes activating a form-fill feature on a toolbar to execute computer software running on computer hardware to detect in the form displayed on the web page user-selectable fields for data input. Computer software is executed to group fields of unique address information, unique credit card information, and unique login and password information appearing in the form. In the form, uniquely identified and group address fields, credit card information fields, and login and password fields are shaded in different colors.

In a final aspect, a method for selecting address, password, and credit card clusters is provided. The method includes operating a web browser to display forms from websites. A toolbar connected to the web browser is operated with selectable buttons. A form-fill button on the toolbar is selected to populate data in forms located in the web browser and to open a drop-down menu with selectable elements.

### BRIEF DESCRIPTION OF THE SEVERAL VIEWS OF THE DRAWINGS

The present invention is described in detail below with reference to the attached drawing figures, which are incorporated herein by reference, and wherein:

FIG. 1 is a block diagram of an exemplary system illustrating an embodiment of the present invention;

FIG. 2 is a flowchart illustrating an exemplary process for operating an embodiment of the present invention;

FIG. 3 is a diagram of an exemplary operating environment illustrating an embodiment of the present invention;

FIG. 4 is a diagram of an exemplary operating environment illustrating an embodiment of the present invention;

FIG. 5 is a diagram of an exemplary operating environment illustrating an embodiment of the present invention;

FIG. 6 is a diagram of an exemplary operating environment illustrating an embodiment of the present invention;

FIG. 7 is a diagram of an exemplary operating environment illustrating an embodiment of the present invention;

FIG. 8 is a diagram of an exemplary operating environment illustrating an embodiment of the present invention;

FIG. 9 is a flowchart illustrating an exemplary process for detecting data fields in accordance with an embodiment of the present invention; and

FIG. 10 is a flowchart illustrating an exemplary process for creating profiles and filling forms in accordance with an embodiment of the present invention.

### DETAILED DESCRIPTION OF THE INVENTION

The present invention will be better understood from the detailed description provided below and from the accompanying drawings of various embodiments of the invention, which describe, for example, methods to use a tool and web browser to automatically fill forms with user information. The detailed description and drawings, however, should not be read to limit the invention to the specific embodiments. Rather, these specifics are provided for explanatory purposes that help the invention to be better understood.

FormFill is a tool that provides users an ability to fill data into fields on web pages from information they have previously entered. This information includes a set of profiles such as personal information, addresses, telephone numbers, credit cards, logins and passwords. The tool identifies and fills in fields in web pages with this information.

Having briefly described an overview of the present invention, an exemplary operating environment for the present invention is described below.

Exemplary Operating Environment

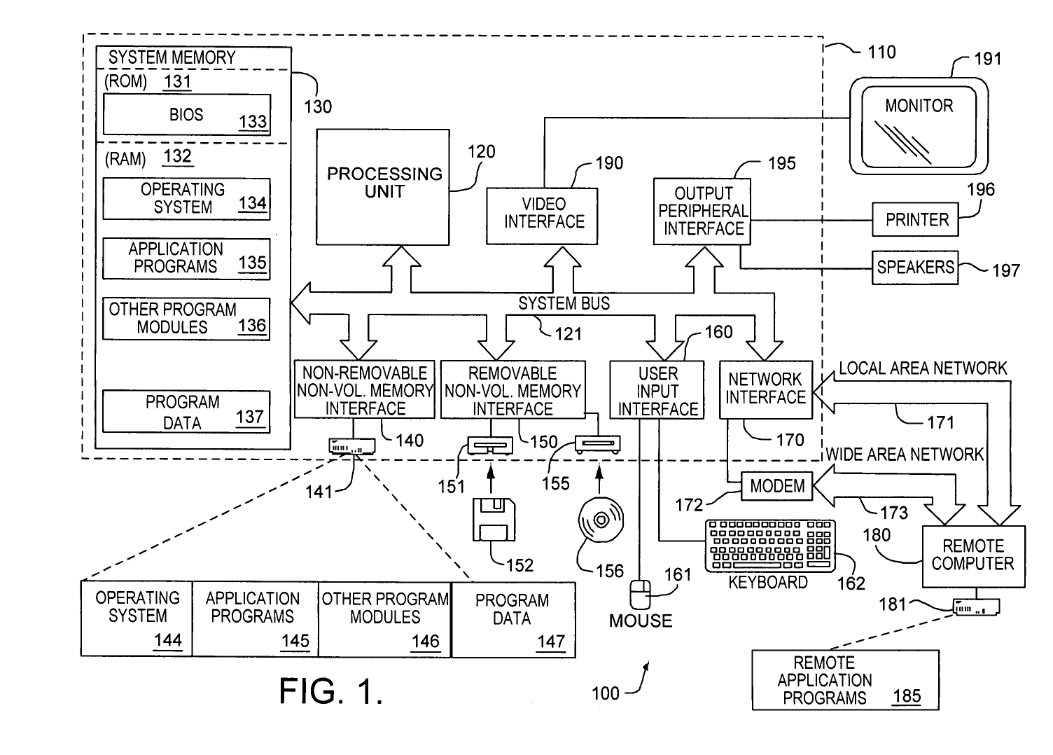

Referring to the drawings in general and initially to FIG. 1 in particular, wherein like reference numerals identify like components in the various figures, an exemplary operating environment for implementing the present invention is shown and designated generally as computing system environment 100. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the present invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks (DVDs), digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other programs 146 and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the network interface 170, or other appropriate mechanism. In a networked environment, program modules depicted relative to the computer 110, or portions thereof, may be stored in a remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

When the computer 110 is turned on or reset, the BIOS 133, which is stored in the ROM 131, instructs the processing unit 120 to load the operating system, or necessary portion thereof, from the hard disk drive 141 into the RAM 132. Once the copied portion of the operating system, designated as operating system 144, is loaded in RAM 132, the processing unit 120 executes the operating system code and causes the visual elements associated with the user interface of the operating system 134 to be displayed on the monitor 191. Typically, when an application program 145 is opened by a user, the program code and relevant data are read from the hard disk drive 141 and the necessary portions are copied into RAM 132, the copied portion represented herein by reference numeral 135.

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between the various steps herein disclosed unless and except when the order of individual steps is explicitly described.

Automatic Form Fill

With the present invention, the first time that a tool detects a form with one or more “fillable” fields it presents a user with a first-run dialog. This dialog informs the user about the tool, and has a button to launch a FormFill wizard. The wizard gives the user an opportunity to enter personal information, credit card information, and login and password information. This information is stored in the tool for subsequent use. The first-run dialog may only be shown once in order to establish initial information with the user. For subsequent data entry, the user may input and change data in an options section of the tool. The user may access options from a drop-down menu next to a “FormFill” button on a toolbar, or from options of other components. The tool has several option pages of which several shall be discussed below.

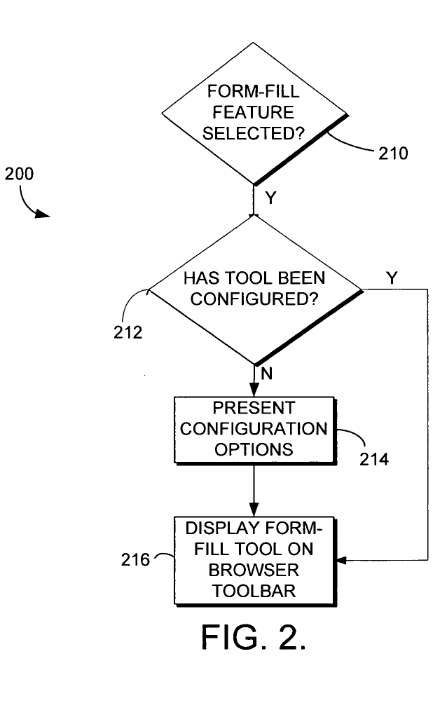

In FIG. 2, a method 200 is described in which a FormFill tool is provided to the user within a web browser. Initially, a determination is made, as shown at 210, whether the FormFill tool option has been selected by the user. If the user has selected FormFill, a determination is made whether the tool has previously been configured by the user, as shown at 212. If the user has previously configured the tool, the tool is simply provided in the toolbar of the browser, as is more fully described below. If the user has not yet configured the tool, a number of options and configuration settings are provided, along with a request for information, as shown at 214. This can be achieved in a variety of ways, such as through provision of a set-up wizard. In this configuration step, options are presented to the user regarding basic operation of the tool. For example, the user can configure the tool to automatically fill in address information in a form, if address fields are found. The user could also configure the tool to enter sign-in information automatically, save website sign-in information, or overwrite existing text in forms. Each of these options is discussed in further detail below. Additionally, the user preferably is prompted to establish or create a password for use with the tool. The user is also prompted to enter basic information typically needed in completing web-based forms. As discussed in greater detail below, the user preferably enters personal information, such as address information. Preferably, address information is entered for commonly used billing and shipping addresses. Additionally, commonly used credit card information is entered. Finally, the user may be prompted to enter any sign-in information for commonly used web-sites. After the tool is configured, and the tool is “turned on” by the user, the FormFill tool is presented to the user on the toolbar as shown at 216. If the user desires to change the configuration settings, such as adding an additional address, the user can return to the toolbar settings and change the settings or add information.

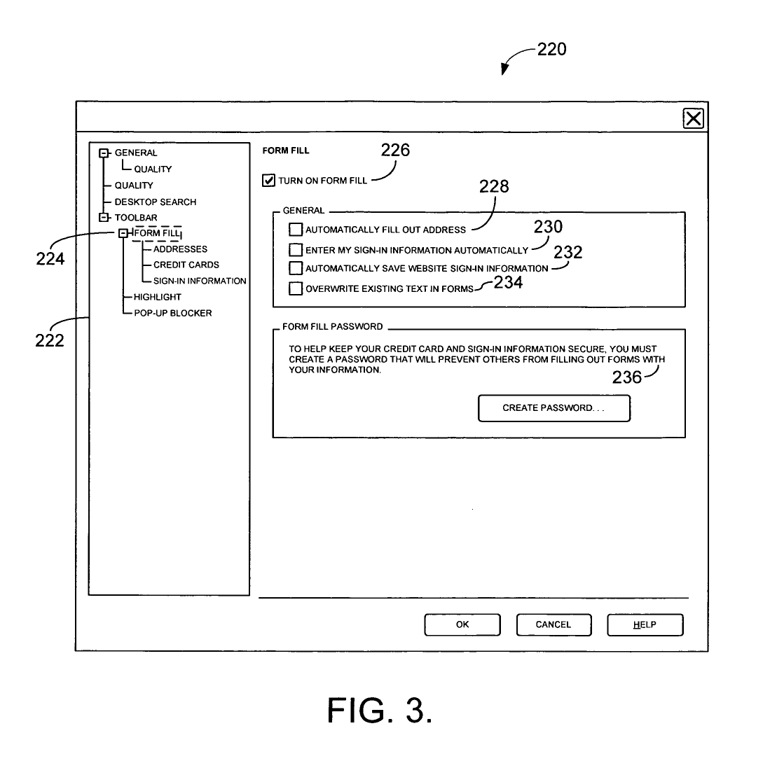

In FIG. 3, an exemplary schematic screen display of the FormFill tool configuration options 220 is shown. FormFill options 220 illustrates several configuration settings available to the user to control and customize the tool to the preferences of the user. FormFill options 220 is a standard dialog created from the operating computer software. It pops up as a window on a display at the computing device. Although it is shown as one embodiment of the present invention in FIG. 3, other embodiments may be implemented illustrating more or less data than is shown for FormFill options 220.

On the left side of the window in FormFill options 220, a folder list 222 provides the user with potential access to other data. Folder List 222 contains several entries which may be selected to bring up windows of other information to the user. In the current depiction, folder list 222 contains a form fill heading, Form Fill 224, with subheadings for addresses, credit cards, and sign-in information. By selecting Form Fill 224 in folder list 222, corresponding information to the right of folder list 222 is illustrated in FormFill options 220. The user may view at all times the current status of the tool in this window. The user may select to turn on or turn off the tool in selection control 226. If this box is left unchecked, the tool will turn off and not operate on forms that become available when accessing web pages.

In addition to selection control 226, additional general information may be provided to the user for flexibility and control. The user may select to have address information automatically filled in a form through selection control 228. When selected, this option will fill out the user's address information that has been populated in the tool. Otherwise, when not selected, the user may manually select the “Form Fill” button located on a toolbar in order for data to be filled into the form. The user may select to have sign-in or login and password information entered automatically by the tool as indicated in selection control 230. The user may select to automatically save this website sign-in information as indicated in selection control 232. This option alleviates the user from retyping information on the web page when browsing within a domain. The user also has the option to select to have text overwritten in selection control 234.

Another aspect of FormFill options 220 allows the user to establish a password to access information pertaining to secure information such as credit card information, sign-in information, and login and password information as indicated by create password control 236. The user uses control 236 to create the password to be used when accessing sensitive or private information. This password is required whenever sensitive or private information is used, accessed, or modified. In addition, the password may be retrieved from a computer program or authentication system, or may be re-used from being previously entered.

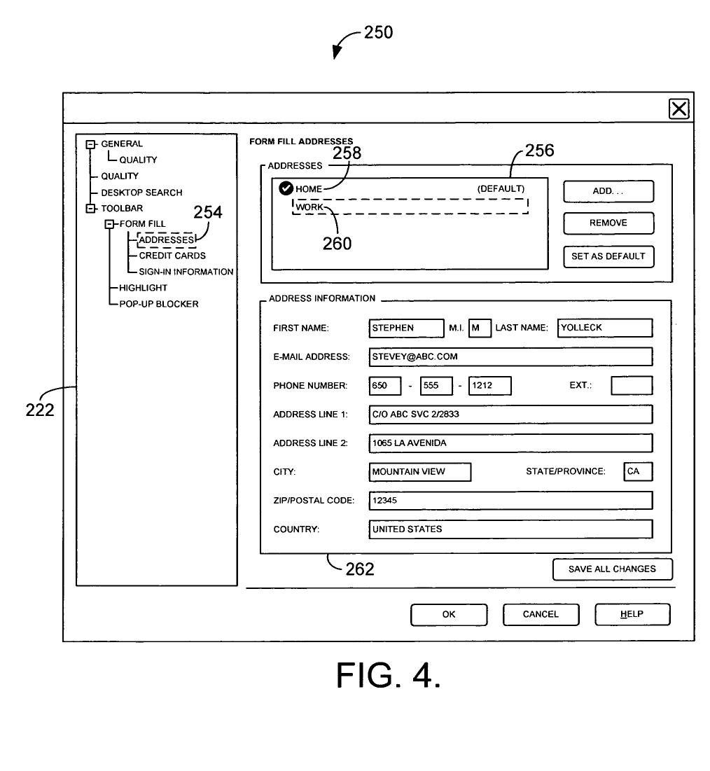

Now referring to FIG. 4, address options 250 illustrates a schematic window display of information pertaining to personal information of the user. In this window, address information may be reviewed, modified, updated, and deleted. Address options 250 contains folder list 222, as discussed with respect to FIG. 3. By selecting addresses 254, the window of information pertaining to personal information of the user is shown to the right of folder list 222. In the upper portion of the window, the user may view all the addresses that have been placed in the tool. In the embodiment, the user has already stored a home address 258 and a work address 260 as shown in a box 256 in address options 250. To the right of box 256, the user may opt to add additional addresses to, or remove addresses from, the tool.

By highlighting work address 260 in address options 250, the user's information is detailed below in an address information display 262. One may appreciate the flexibility that this embodiment provides in allowing the user to enter multiple addresses for use with the tool. By having multiple addresses stored in the tool, the user has flexibility in selecting which addresses the tool uses to populate forms that appear on web pages. If the user desires to change address information, modifications may be made in the available fields in address information 260.

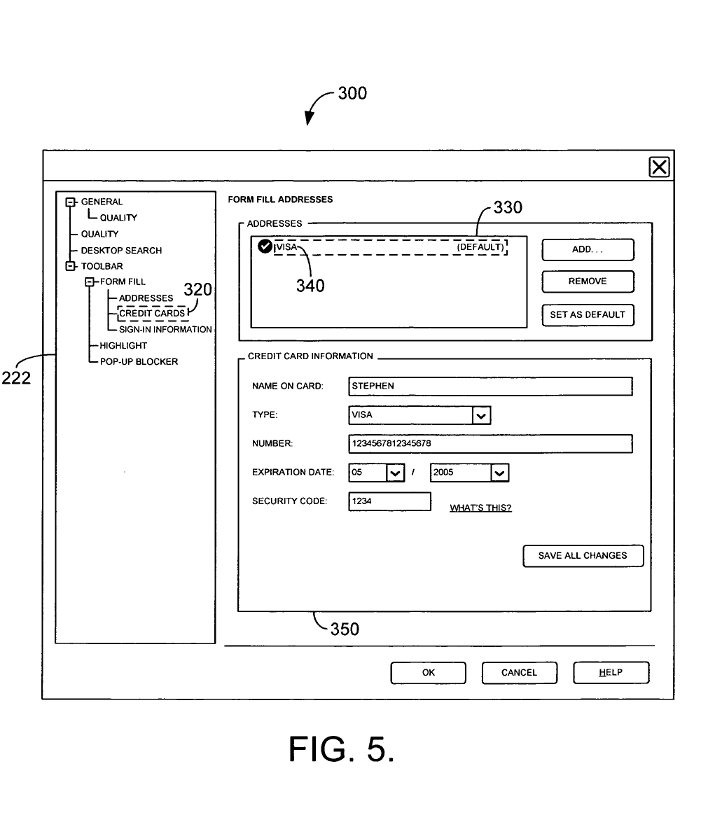

Now turning to FIG. 5, a schematic window display for credit card information is shown in a credit card options 300. Credit card options 300 contains a folder list 222 with user-selectable items to access data. Although a list of information is provided in folder list 222, different information may be listed in folder list 222 in a different embodiment to practice the present invention. In the current embodiment, folder list 222 contains a subheading credit cards 320 selected to provide more detailed information about credit cards 320 to the right of folder list 222. By selecting credit cards 320, property page information appears to the right of folder list 222 in credit card options 300. A box 330 appears in the top portion of credit card options 300 containing a list of credit cards that have been added to credit card options 300 as shown by a user-selected name, such as a visa 340. Visa 340 corresponds to credit card information stored in the tool. Additional credit card information may be stored in the tool and tagged with an additional user-selected name. An additional entry using the “Add” button places another entry in the list under visa 340. For illustrative purposes here, only one entry, visa 340, has been made. However, the user may add more entries for use. Also, the user may delete or change entries at any time.

In a credit card information box 350, details of the visa 340 entry are shown. When visa 340 is selected in box 330, the details are provided below box 330 showing the information that has been populated in the tool. In this embodiment, the name on the credit card, type of credit card, credit card number, expiration date, and security code are provided in credit card information 350 to indicate the information that has been stored. One may appreciate that the information provided here is illustrative and that different data may be configured to provide a different set of credit card data under credit card information 350.

When data is shown in credit card information 350, it may be modified and saved as a new entry in box 350 or saved as an update to an existing entry, like visa 340.

One may appreciate the flexibility that this embodiment offers in allowing the user to enter multiple credit cards for use with the tool. By having multiple credit cards stored in the tool, the user has flexibility in selecting which credit card to use to populate forms that appear on web pages. If the user desires to change credit card information, modifications may be made in the available fields in credit card information 350.

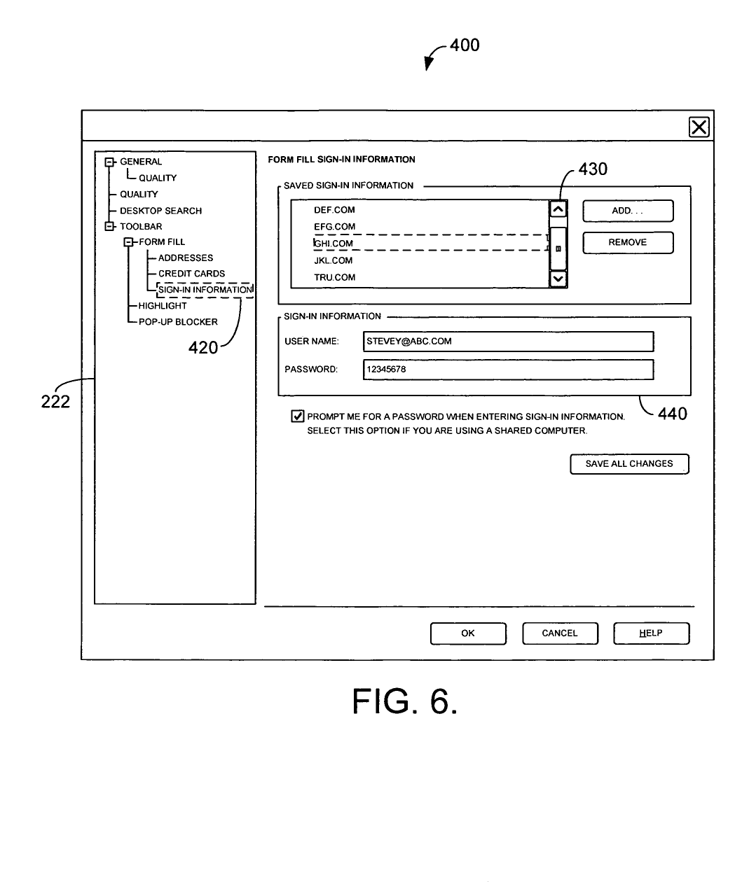

In FIG. 6, a schematic illustration of a window for sign-in options 400 is shown. The illustration shows a folder list 222 relating to user-selectable data with a sign-in subheading 420 selected to depict data to the right of folder list 222.

By selecting sign-in 420, a box 430 is shown to provide a list of domains that may be accessed or may require passwords for access to information in the domains. Box 430 contains a list of saved domains relating to login and password information populated by the user. The tool allows the user to automatically populate fields requiring login and password information from the domains that are encountered in the web page. The tool also allows for login and password information stored in the tool to be re-used without prompting the user to provide the same again.

When one of the entries in box 430 is selected, details about the stored login and password information are provided in sign-in details display 440. Here, GHI.com is selected and a user name and password are provided in sign-in details display 440. The user may view, change, or delete information shown in sign-in details 440. New entries may be added to box 430 giving the user flexibility in choosing which sign-in data to use for a particular web site access.

As shown above, folder list 222 is illustrated with similar information down a left-side of each window in the several figures. One may appreciate that different information may be shown in any location in the same window. More particularly, by selecting different subheadings located in the folder list 222, the user may access different pages of data within the same window for the present invention. However, other embodiments of the present invention may be implemented allowing new windows to open when accessing data.

For the embodiments shown in FIGS. 5 and 6, security techniques are, or may be, implemented to protect sensitive or private information. Although not shown in the illustrations of FIGS. 5 and 6, password information is preferably required whenever credit card information or sign-in information are to be accessed. Password information may be requested in a variety of ways including a pop-up window, a password field in the form, or a reading of the keyboard strokes with no visible interface or entry. The purpose of the security technique is to protect sensitive or private information provided by the user from disclosure to others. However, this is only one embodiment of the present invention and other embodiments may be implemented without the security feature or with a different type of security feature.

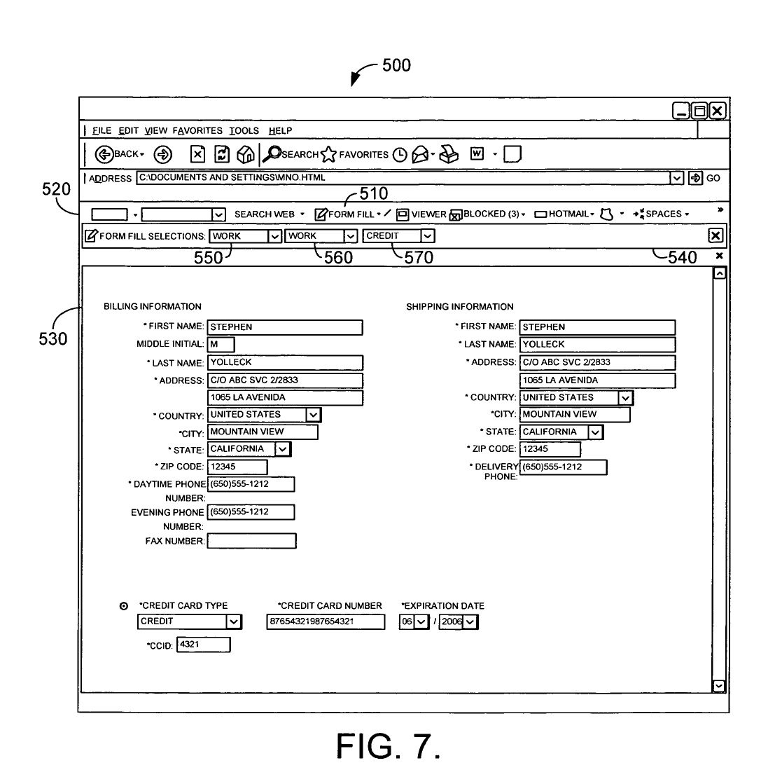

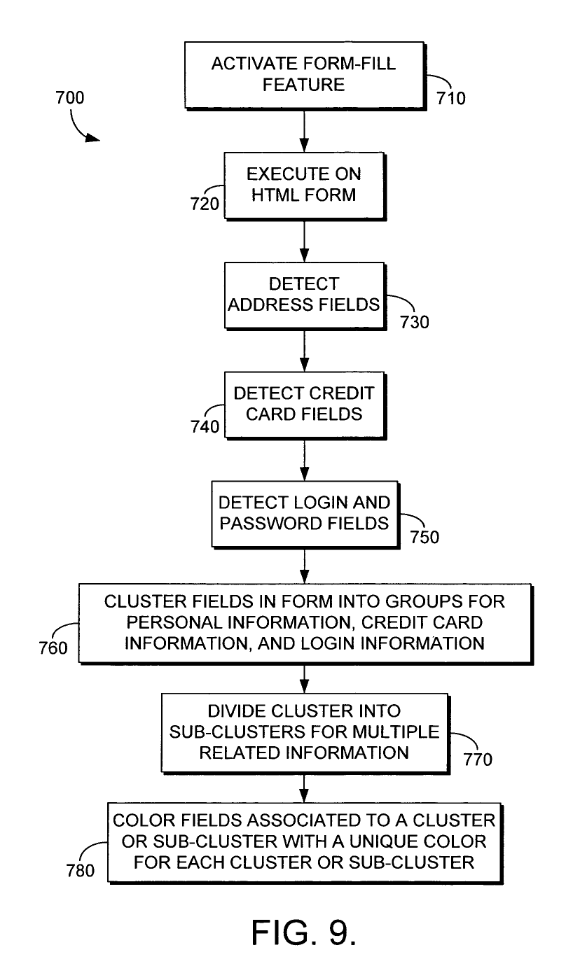

Prior to a general discussion of the tool in operation, and turning to FIG. 9, a process is first described for detecting data fields encountered in a form. In a step 710, the Form-Fill tool is activated. Preferably, this can be accomplished through a button or control on a toolbar, as discussed in greater detail below with reference to FIG. 7. The activation of the FormFill tool initializes and executes computer software associated with the form-fill tool, toolbar, and web pages.

The computer software that executes to operate the form-fill tool may be stored on and distributed across a variety of sources. For example, portions of the computer software may execute on the computing device, while other portions execute across a distributed network. In one embodiment of the present invention, computer software executing on the computing device interacts with HTML files encountered by the computing device in order to detect forms in web pages as described in a step 720. In step 720, the HTML files are examined to determine whether the page contains a form.

In steps 730, 740, and 750, the HTML files are more particularly examined to identify personal address fields, credit card fields, and login and password fields, respectively, in any identified forms. The form-fill tool takes an ordinary form encountered on any web page and analyzes the HTML information to determine the existence of any form fields. When form fields are identified, the form-fill tool also determines whether the form fields are associated with address information, credit card information, and/or login and password information. In addition, the form-fill tool further determines whether there are multiple addresses within a form, such as both a billing address and a shipping address. The fields are then clustered together by type as shown at step 760. More specifically, personal information is grouped together; credit card information is grouped together; and login and password information is grouped together. Because address fields may contain more than one address, the form-fill tool performs a further subdivision of the address cluster to distinguish between multiple addresses, as shown in step 770. The same subdivision may be performed on multiple fields requesting credit card information, or login and password information.

Using computer hardware and computer software, one approach to accomplish the clustering of related fields is to use pattern matching technology to identify fields in the HTML form. The computer software may associate the fields to clusters, and examine the clusters for certain keywords in order to determine the type of information that is to be filled in the form. For example, the computer software may identify a field, look for adjacent fields, look above and below the current fields, and look for certain word terms near the fields in order to perform the clustering of fields and determine the information that is to go into the fields.

One may note that other computer software approaches may be employed to accomplish the same tasks as mentioned above. The computer software approach mentioned above is exemplary as to how the recognizing, selection, and clustering of fields occurs for the tool.

With information separated into clusters and sub-clusters, the form-fill tool preferably displays each clustered information set in a unique color, allowing the user to recognize associated information and distinguish it from other information, as shown in step 780. Additionally, a form may be too large to be completely displayed at once. If the user has to scroll through information to view fields of information, the colored cluster sets aid the user in recognizing associated fields.

Without reference to a particular computer software approach, one may think of the steps discussed above as occurring in three phases: Phase 1 occurs with the searching for fields across the form, and determining the types of fields that are in the form using parsing; phase 2 occurs with grouping the fields into clusters or sub-clusters, and making a determination as to what information is to be associated with the cluster or sub-cluster; and phase 3 occurs with recognizing if there are more than one type of similar information populated in the tool, and providing drop-down menu bars that are color-coded to each cluster or sub-cluster.

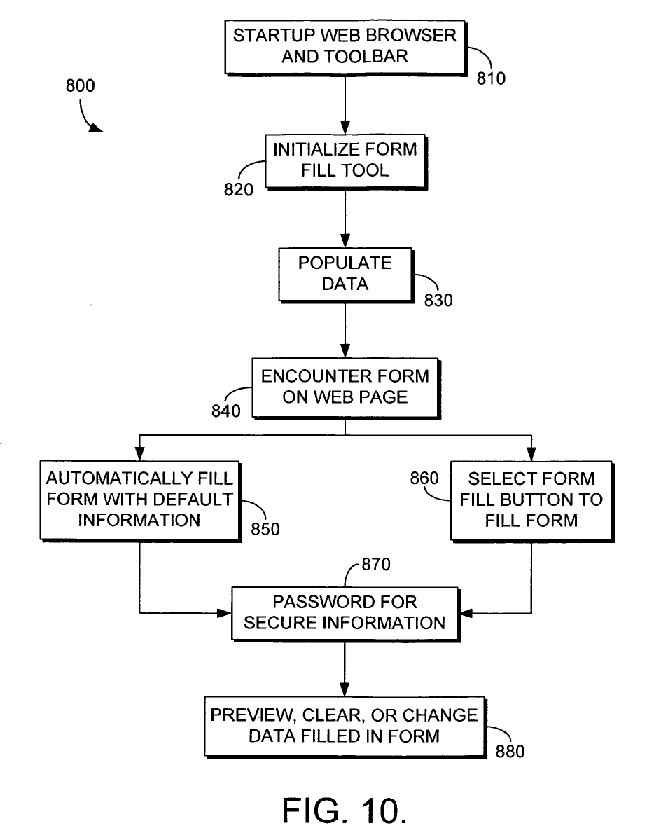

Turning now to FIG. 10, a more general discussion of the operation of the tool is discussed. As shown in FIG. 10, when the user operates the form-fill tool, the user opens a web browser and an associated tool bar in step 810. The user may initialize the form-fill tool as discussed with respect to FIG. 3, as shown at step 820. If the user has not yet configured the tool, the user has an opportunity to populate information into the form-fill tool with personal information, as shown at step 830 and as discussed above with respect to FIG. 3. By pre-populating and storing relevant information, the user is relieved from retyping information when encountering typical forms in a web page. The population of information may be the most arduous task encountered by the user, since it may involve inputting various details. But once the details are stored in the form-fill tool, the user may use the form-fill tool to easily populate forms that are accessed. For example, the user may access a travel web site and decide to purchase an airline ticket. The web site may have fields of data to be populated to enable the user to purchase the airline ticket, shown generally at step 840. When a web page is encountered that requires information to be provided by the user, and if the user has the form-fill tool activated, one of two things occur: 1) The form may be filled automatically with the user's personal information, at step 850; or 2) The user may select a button on the toolbar to have the user's personal information populated into the form, at step 860. Prior to populating the form, the appropriate fields are identified and clustered, as discussed with respect to FIG. 9. In most cases, the user will purchase the airline ticket with a credit card. Credit card information may be populated in accordance with the description above. However, a password is preferably required to enable the information to be automatically populated into the form, at step 870. This additional step provides some level of security for sensitive or private information. For example, if the user shares a computer with another person, the user has some assurance that the user's personal information will be kept private or restricted.

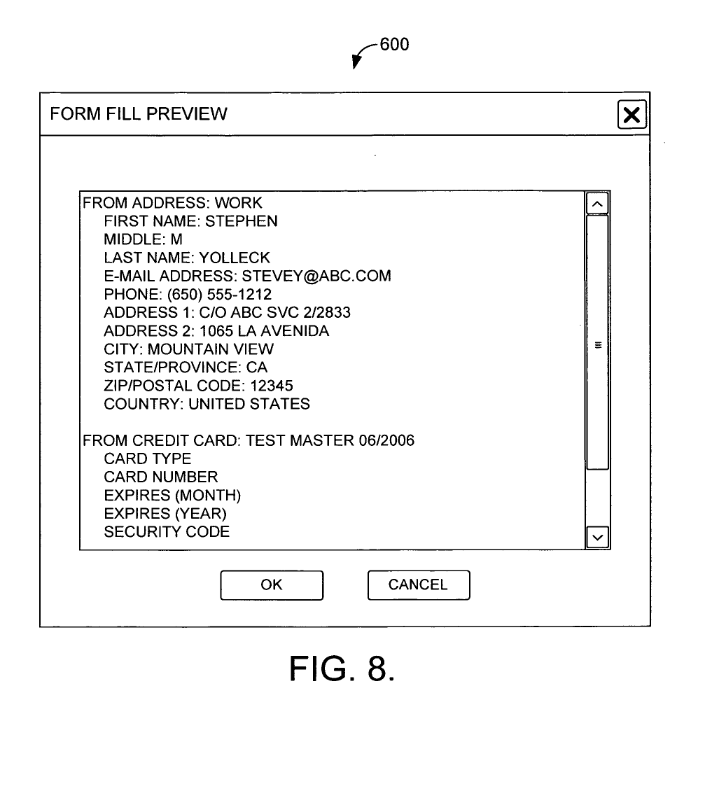

Once the form is populated, the user may still change information in the form. A drop-down bar 540, as discussed below with respect to FIG. 7, provides the user the option of selecting different data, at step 880. In addition, the user may opt to access a preview page to review a compact version of information filled into the form, as discussed below with respect to FIG. 8.

FIG. 7. illustrates an exemplary schematic screen display illustrating operation of the tool. Whenever a web page containing a form is encountered, the tool may be configured to automatically, or at the selection of a button, fill in information stored in the tool, as discussed above with respect to FIG. 3. In the illustration, several aspects of the tool are shown in operation. As shown, a Form Fill icon 510 is located on a toolbar 520. Form Fill icon 510 has two buttons that may be selected to operate the tool. One button with the name “Form Fill” may be depressed to fill in a form on the web page. A second button located next to the first button may be depressed to reveal a drop-down menu of items that may be selected by the user. With the drop-down menu, additional options are displayed, such as to fill in the form, clear the form, or preview the form. The user may also access additional selectable elements such as settings or options within the drop-down menu. In some instances, the first button may not be needed, such as if the tool has been configured to automatically fill in information when a form is encountered on the web page.

As shown, personal information, credit card information, and login and password information stored in the tool may be used to fill in a form 530 containing billing information, shipping information, and credit card information. The tool may be configured to automatically fill in the information when the form is initially encountered or may be configured to allow the user to depress form fill icon 510 to fill in the information. In FIG. 7, personal information and credit card information have been used to fill in information for the available fields using information previously entered into the tool by the user. If information is not available, the field may be left blank to allow the user to manually fill in the information. The user may also change information in any field before submitting the data filled in the form.

The invention can also discern different fields and cluster them according to relevant information. Please refer to the discussion above in FIG. 9 for more details. In the illustration of FIG. 7, the fields pertaining to billing information are clustered together for one type of address information. Although not shown, the cluster may be identified by fields of similar background color. Likewise, the fields pertaining to shipping information may be clustered together for another type of address information. This cluster may have a different background color for its relevant address fields separate from the address fields for the billing information. And, the fields for credit card information may be clustered together in yet another color.

When data is filled in the form, drop-down bar 540 appears when the user has several entries available for personal information, credit card information, and/or login and password information. As stated above, personal information, credit card information, and login and password information are shown in clusters and colored accordingly. For example, fields relating to personal information may be clustered and colored a particular color for a first address in the form. Fields relating to personal information may be clustered and colored another color for a subsequent address and so forth. Fields for credit card information may be treated accordingly and clustered with a unique color. Drop-down bar 540 has boxes that appear whose background color matches the background color of the fields on the page in the same cluster. In the illustration here, three boxes appear corresponding to the three clusters of information shown in form 530. A first box 550 indicates a work address used for billing information. One may note that the work address may very well correspond to work address 260 mentioned above in FIG. 4. As mentioned earlier, first box 550 in drop-down bar 540 may have a background color corresponding to the cluster of address fields for billing information. A second box 560 in drop-down bar 540 indicates the same work address used for shipping information. Second box 560 may have another background color corresponding to the address fields for shipping information. One may note that the box color for first box 550 and second box 560 may be different since their information correspond to different clusters. A third box 570 indicates a credit card and corresponds to the fields requiring credit card information in the form. Again, the background color of third box 570 corresponds to the cluster of fields for credit card information.

One ordinarily skilled in the art may realize that the embodiment of the present invention provides the user flexibility in changing and updating form information even after data has been filled in the form. Drop-down bar 540 provides the user access to stored information to allow the user to change information before a selection is permanently made or submitted. The user is not restricted to one set of form information and may readily choose from multiple sets of personal information, credit card information, and login and password information to suit needs. Furthermore, data may flexibly be interchanged and used together depending upon the circumstances. For example, the user may use a home address for billing purposes, a work address for shipping purposes, and a personal credit card. Then later, the user may use the work address for billing purposes and a business credit card even if encountering the same form on the same web page as before.

Sometimes, the user may have a form filled automatically with fields scattered throughout the web page. It may be difficult for the user to see all the data that has been filled. As a result, in FIG. 8, a preview page 600 may be accessed in the tool to give the user a compact view of the data to be filled or has been filled in the form. Depending on the data that was filled or will be filled, the data is shown in preview page 600. Preview page 600 allows the user to verify information in one place without manually scanning the entire form searching for information. If changes are needed from using preview page 600, the user may opt to make modifications directly on the form as in FIG. 7 or may access any one of the option pages discussed earlier in FIGS. 3-6.

The invention claimed is:

1. A computer-implemented method for automatically filling forms on a web page, comprising:
at a computing device, operating a web browser and a form-fill tool in communication with the web browser;
populating from a data source data fields in the form-fill tool corresponding to one or more profiles;
detecting a form having fields presented to the user at the computing device;
populating, by the form-fill tool, data corresponding to the form fields using the pre-populated data in the form-fill tool; and
displaying one or more user-selectable categories corresponding to one or more grouped profiles, the user-selectable categories containing a listing of profiles to allow a user to select a different profile to change information previously populated in one or more forms.

2. The method of claim 1, wherein the data source comprises at least one of a user inputting data and a computer software executing to retrieve information from an address book.

3. The method of claim 2, wherein populating, by the form-fill tool, data corresponding to the form fields using the populated fields in the form-fill tool comprises selecting a form-fill button associated with the form-fill tool on the toolbar to automatically populate data fields in one or more forms displayed in a web page with data pre-populated and stored in the form-fill tool.

4. The method of claim 2, wherein populating, by the form-fill tool, data corresponding to the form fields using the populated fields in the form-fill tool comprises automatically populating by the form-fill tool data fields in one or more forms displayed in the web page without manual intervention and with data pre-populated in the form-fill tool.

5. The method of claim 2, further comprising a use of password required for the data pre-populated in the form-fill tool associated with secure information.

6. The method of claim 5, wherein one or more user-selectable categories comprises one or more categories appearing on the web page to allow the user to select one or more profiles located within each category, each category associated with one or more fields in the one or more forms.

7. The method of claim 6, wherein one or more grouped profiles comprises profiles of similar information clustered together into one or more categories.

8. The method of claim 7, further comprising shading fields in the one or more forms with unique colors for each of the one or more categories.

9. A computer readable medium having instructions stored thereon for performing the method of claim 1.

10. A computer-implemented method for detecting data fields in a form displayed on a web page comprising:
detecting in the form displayed on the web page fields for data input;
grouping associated fields into clusters; and
shading in a different color in the form displayed on the web page each cluster.

11. The method of claim 10, wherein the cluster is selected from the group comprising address fields, credit card information fields, and login and password fields.

12. The method of claim 10, further comprising:
identifying fields on an HTML form to be filled;
clustering fields on the HTML form;
and shading the clustered fields into different colors for each cluster.

13. A computer readable medium having instructions stored thereon for performing the method of claim 10.

14. A method for selecting address, password, and credit card clusters comprising:
operating a web browser to display one or more forms from a plurality of websites;
operating a toolbar connected to the web browser with one or more selectable buttons on the toolbar; and
selecting a form-fill button located on the toolbar to populate data in the one or more forms located in the display of the web browser and to open a drop-down menu with one or more selectable elements.

15. The method of claim 14, further comprising a preview form page generated from the selection of the preview form category within the drop-down menu operable to provide a display of the data to be populated in one or more forms.

16. The method of claim 14, further comprising at least one of a settings page and an options page generated from the selection of at least one of the settings category and options category within the drop-down menu to display an options page comprising at least one of a folder list and a set of user-selectable data fields to customize the form-fill activity.

17. The method of claim 16, wherein the set of user-selectable data fields to customize the form-fill activity comprises at least one of a choice to turn on form fill, to automatically fill out address information, to enter sign-in information automatically, to automatically save website sign-in information, to overwrite existing text in forms, to set a password, to delete password information, and to change password information.

18. The method of claim 16, further comprising selecting an addresses heading in the folder list to display associated address information, the associated address information comprising at least one of a listing of one or more pre-populated addresses, no listing of pre-populated addresses, the ability to add, remove, or set as default a particular address, and the ability to select an address listing to display its address contents.

19. The method of claim 16, further comprising selecting a credit cards heading in the folder list to display associated credit card information details, the credit card information details comprising at least one of a listing of one or more pre-populated credit cards, no listing of pre-populated credit cards, the ability to add, remove, or set as default a particular credit card, and the ability to select a credit card listing to display its credit card contents, and the credit card information details accessible through the use of a password at least once for a current internet session.

20. The method of claim 16, further comprising selecting a sign-in information heading to display associated sign-in information details, said sign-in information details comprising at least one of a listing of one or more pre-populated sign-in information, no listing of pre-populated sign-in information, the ability to add or remove a particular sign-in information, and the ability to select a sign-in information listing to display its associated user name and password, and the sign-in information details accessible through the use of a password at least once for a current internet session.

21. A computer readable medium having instructions stored thereon for performing the method of claim 11.
